(19) United States
(12) Patent Application Publication
(10) Pub. No.: US 2021/0230783 A1
(43) Pub. Date: Jul. 29, 2021

(54) METHOD OF USING IMAGE RECOGNITION PROCESSES FOR IMPROVED OPERATION OF A LAUNDRY APPLIANCE

(71) Applicant: Haier US Appliance Solutions, Inc., Wilmington, DE (US)

(72) Inventors: Khalid Jamal Mashal, Louisville, KY (US); Juan Manuel Huerta, Louisville, KY (US)

(21) Appl. No.: 16/750,279

(22) Filed: Jan. 23, 2020

(51) Int. Cl. D06F 34/18; D06F 34/08; G06T 7/11; G06N 3/04

(52) U.S. Cl. CPC D06F 34/18; D06F 34/08; D06F 2103/06; G06N 3/04; G06T 7/11

(57) ABSTRACT

A washing machine appliance includes a wash tub defining a wash chamber, a wash basket rotatably mounted within the wash tub, and a camera mounted within the cabinet in view of the wash chamber. A controller is operably coupled to the camera for obtaining images of the load of clothes in the wash chamber and analyzing the images using a neural network image recognition process (such as a Mask R-CNN process) to determine a load characteristic of the load of clothes. The load characteristic can then be used to adjust at least one operating parameter of the washing machine appliance based on the load characteristic, e.g., for improved or optimized wash performance.

### FIELD OF THE INVENTION

The present subject matter relates generally to washing machine appliances, or more specifically, to systems and methods for using image recognition processes to improve or optimize operation of washing machine appliances

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Notably, it is frequently desirable to understand characteristics of a load of clothes within the washing machine appliance, e.g., in order to optimize water usage, agitation time, agitation profile selection, and other wash parameters. For example, certain loads (e.g., towels or linens) may require more water and detergent, increased water temperature, and stronger agitation cycles. By contrast, other loads (e.g., such mixed color loads or delicates) may require cooler water and a more gentle agitation profile. However, conventional washing machine appliances require a user to select operating cycles or specify the type of load added to the wash chamber, often resulting in inaccurate inputs or sub-optimal cycle settings.

Accordingly, a washing machine appliance with features for improved wash performance would be desirable. More specifically, a system and method for automatically detecting characteristics of the load of clothes and determining preferred operating parameters would be particularly beneficial.

### BRIEF DESCRIPTION OF THE INVENTION

Advantages of the invention will be set forth in part in the following description, or may be apparent from the description, or may be learned through practice of the invention.

In accordance with one exemplary embodiment of the present disclosure, a washing machine appliance is provided including a wash tub positioned within a cabinet and defining a wash chamber, a wash basket rotatably mounted within the wash tub and being configured for receiving of a load of clothes for washing, a camera mounted within the cabinet in view of the wash chamber, and a controller operably coupled to the camera. The controller is configured for obtaining one of more images of the load of clothes in the wash chamber using the camera, analyzing the one or more images using a neural network image recognition process to determine a load characteristic of the load of clothes, and adjusting at least one operating parameter of the washing machine appliance based on the load characteristic.

In accordance with another exemplary embodiment of the present disclosure, A method of operating a washing machine appliance, the washing machine appliance including a wash tub positioned within a cabinet and defining a wash chamber, a wash basket rotatably mounted within the wash tub and being configured for receiving of a load of articles for washing, and a camera mounted within the cabinet in view of the wash chamber. The method includes obtaining one of more images of the load of clothes in the wash chamber using the camera, analyzing the one or more images using a neural network image recognition process to determine a load characteristic of the load of clothes, and adjusting at least one operating parameter of the washing machine appliance based on the load characteristic.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary washing machine appliance according to an exemplary embodiment of the present subject matter.

FIG. 2 provides a side cross-sectional view of the exemplary washing machine appliance of FIG. 1.

FIG. 3 provides a schematic view of a door and gasket sealed against a cabinet of the exemplary washing machine of FIG. 1, along with a camera mounted within the gasket according to an exemplary embodiment of the present subject matter.

FIG. 4 illustrates a method for operating a washing machine appliance in accordance with one embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

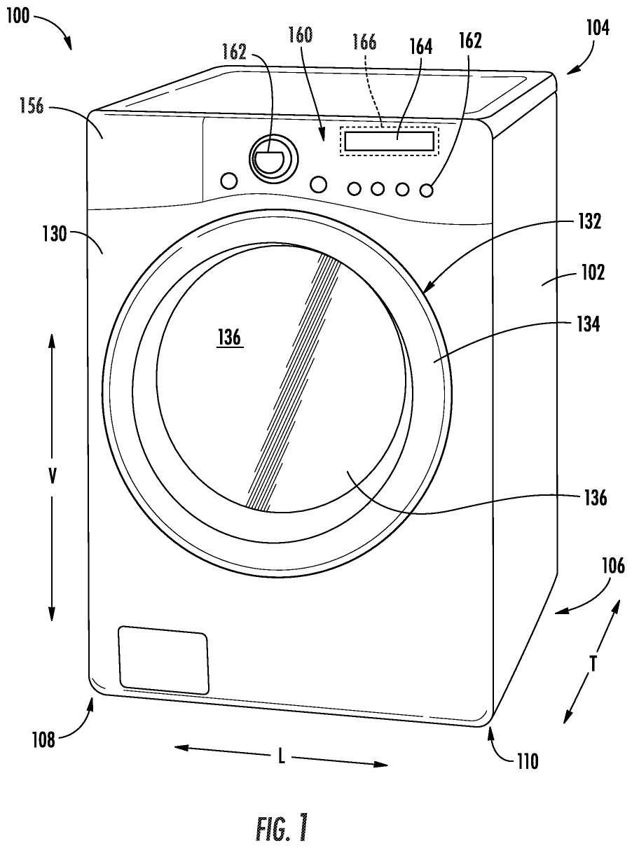

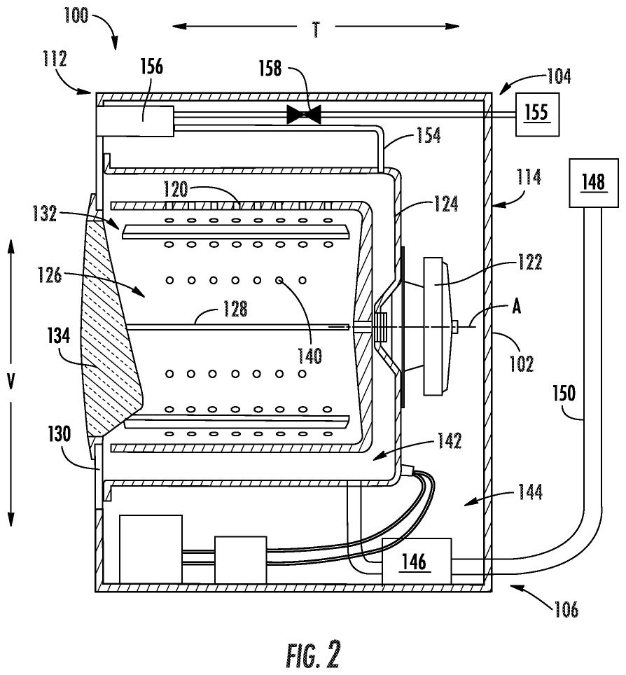

Referring now to the figures, an exemplary laundry appliance that may be used to implement aspects of the present subject matter will be described. Specifically, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction, and between a front 112 and a rear 114 along the transverse direction T.

Referring to FIG. 2, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout 154 is configured for directing a flow of fluid into wash tub 124. For example, spout 154 may be in fluid communication with a water supply 155 (FIG. 2) in order to direct fluid (e.g., clean water or wash fluid) into wash tub 124. Spout 154 may also be in fluid communication with the sump 142. For example, pump assembly 144 may direct wash fluid disposed in sump 142 to spout 154 in order to circulate wash fluid in wash tub 124.

As illustrated in FIG. 2, a detergent drawer 156 is slidably mounted within front panel 130. Detergent drawer 156 receives a wash additive (e.g., detergent, fabric softener, bleach, or any other suitable liquid or powder) and directs the fluid additive to wash chamber 124 during operation of washing machine appliance 100. According to the illustrated embodiment, detergent drawer 156 may also be fluidly coupled to spout 154 to facilitate the complete and accurate dispensing of wash additive.

In addition, a water supply valve or control valve 158 may provide a flow of water from a water supply source (such as a municipal water supply 155) into detergent dispenser 156 and into wash tub 124. In this manner, control valve 158 may generally be operable to supply water into detergent dispenser 156 to generate a wash fluid, e.g., for use in a wash cycle, or a flow of fresh water, e.g., for a rinse cycle. It should be appreciated that control valve 158 may be positioned at any other suitable location within cabinet 102. In addition, although control valve 158 is described herein as regulating the flow of “wash fluid,” it should be appreciated that this term includes, water, detergent, other additives, or some mixture thereof.

A control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users.

Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through opening 132, and washing operation is initiated through operator manipulation of input selectors 162. Wash tub 124 is filled with water, detergent, and/or other fluid additives, e.g., via spout 154 and or detergent drawer 156. One or more valves (e.g., control valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain pump assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through opening 132.

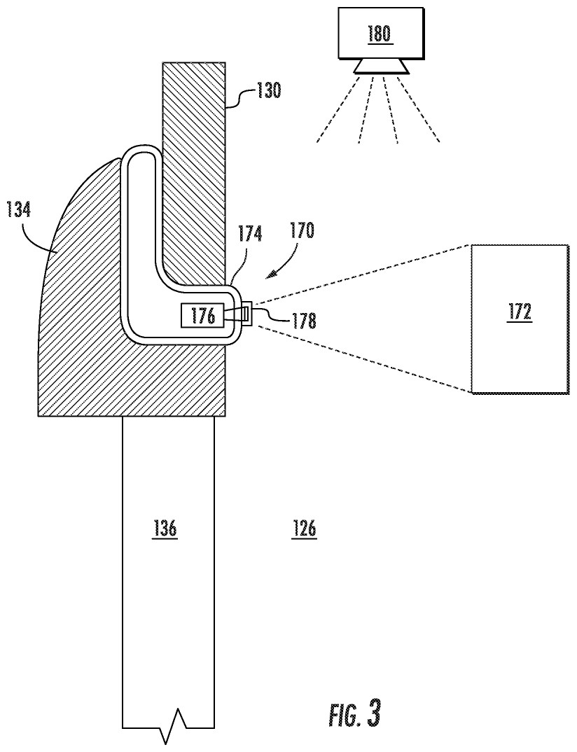

Referring now briefly to FIG. 3, washing machine appliance 100 may further include a camera assembly 170 that is generally positioned and configured for obtaining images of a load of clothes (e.g., as identified schematically by reference numeral 172) within wash chamber 126 of washing machine appliance 100. Specifically, according to the illustrated embodiment, camera assembly 170 is mounted within a gasket 174 that is positioned between a front panel 130 of cabinet 102 and door 134. Although an exemplary camera assembly 170 is illustrated and described herein, it should be appreciated that according to alternative embodiments, washing machine appliance 100 may include any other camera or system of imaging devices for obtaining images of the load of clothes 172.

Specifically, as illustrated, camera assembly 170 includes a camera 176 positioned within an internal cavity of gasket 174. Camera 176 includes a lens 178 that is constructed from a clear hydrophobic material or which may otherwise be positioned behind a hydrophobic clear lens. So positioned, camera assembly 170 may obtain one or more images or videos of clothes 172 within wash chamber 126, as described in more detail below. Referring still to FIG. 3, washing machine appliance 100 may further include a tub light 180 that is positioned within cabinet 102 or wash chamber 126 for selectively illuminating wash chamber 126 and the load of clothes 172 positioned therein.

Notably, controller 166 (or any other suitable dedicated controller) may be communicatively coupled to camera assembly 170, tub light 180, and other components of washing machine appliance 100. As explained in more detail below, controller 166 may be programmed or configured for analyzing the images obtained by camera assembly 170, e.g., in order to determine the load characteristics of clothes 172 and make informed decisions regarding the operation of washing machine appliance 100.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances. Indeed, it should be appreciated that aspects of the present subject matter may further apply to other laundry appliances, such a dryer appliance. In this regard, the same methods as systems and methods as described herein may be used to monitor a load of clothes in a chamber of the dryer.

Now that the construction of washing machine appliance 100 and the configuration of controller 166 according to exemplary embodiments have been presented, an exemplary method 200 of operating a washing machine appliance will be described. Although the discussion below refers to the exemplary method 200 of operating washing machine appliance 100, one skilled in the art will appreciate that the exemplary method 200 is applicable to the operation of a variety of other washing machine appliances, such as vertical axis washing machine appliances. In exemplary embodiments, the various method steps as disclosed herein may be performed by controller 166 or a separate, dedicated controller.

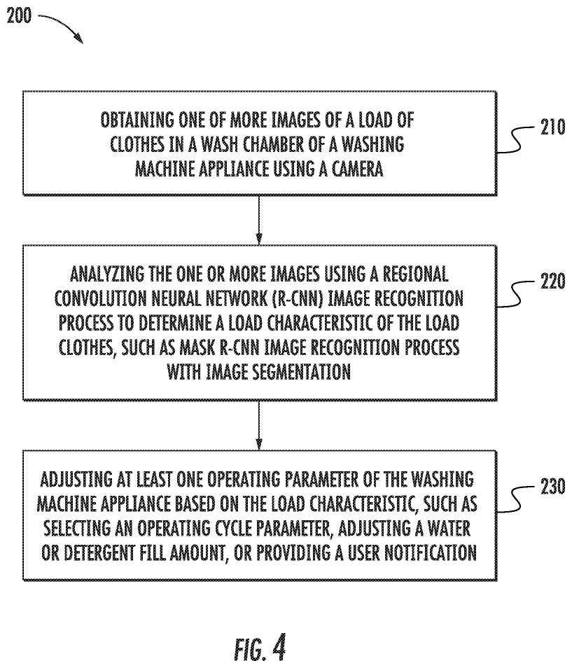

Referring now to FIG. 4, method 200 includes, at step 210, obtaining one or more images of a load of clothes in a wash chamber of a washing machine appliance using a camera. For example, continuing example from above, camera assembly 170 may obtain a plurality of images of clothes 172 within wash basket 120. It should be appreciated that the images obtained by camera assembly 170 may vary in number, frequency, angle, resolution, detail, etc. For example, aspects of the present subject matter may be performed using a single image. By contrast, aspects of the present subject matter may also be performed using a plurality of images taken from different angles, at different times or frequencies, while the wash basket 120 is stationary or rotating, etc. According to an exemplary embodiment, obtaining the one or more images of the load of clothes may include obtaining a first image, tumbling the clothes to achieve a different clothes distribution, and obtaining a second image. In addition, according to exemplary embodiments, controller 166 may be configured for illuminating the tub using tub light 180 just prior to obtaining images.

Step 220 includes analyzing the one or more images using an image recognition process to determine a load characteristic of the load of clothes. As used herein, the term “load characteristic” and the like is intended to refer to any qualitative or quantitative characteristic of clothes 172 within wash chamber 126. For example, the load characteristic may refer to a fabric type, a load color (such as white, light, dark, or mixed), or a load size. In addition, it should be appreciated that the load characteristic may be an approximation or best fit representation of a load of clothes 172. For example, controller 166 may be programmed with thresholds for determining whether a load qualifies as a white load, such as greater than 70% whites, greater than 80% whites, greater than 90% whites, greater than 95% whites, etc.).

In addition to providing approximations regarding primary load characteristics such as type of fabric, color, and size, step 220 may further extract information regarding outliers relative to the average load characteristic. For example, if a load is detected as being primarily white or light colors, an outlier may be a single dark garment within the load (e.g., such as a red sock within a load of whites). In addition, step 220 may extract or identify unwashable items, such as a belt, a wallet, or another item which was likely inadvertently added into wash chamber 126. In sum, step 220 may be used for determining any suitable load characteristic or other feature of a load of clothes 172 that may be useful in adjusting the operation of washing machine appliance to achieve a better outcome, such as improved efficiency, improved wash performance, etc.

As used herein, the terms image recognition, object detection, and similar terms may be used generally to refer to any suitable method of observation, analysis, image decomposition, feature extraction, image classification, etc. of one or more image or videos taken within a wash chamber of a washing machine appliance. It should be appreciated that any suitable image recognition software or process may be used to analyze images taken by camera assembly 170 and controller 166 may be programmed to perform such processes and take corrective action.

According to an exemplary embodiment, controller may implement a form of image recognition called region based convolutional neural network (“R-CNN”) image recognition. Generally speaking, R-CNN may include taking an input image and extracting region proposals that include a potential object, such as an item of clothing (e.g., jeans, socks, etc.) or an undesirable article (e.g., a belt, a wallet, etc.). In this regard, a “region proposal” may be regions in an image that could belong to a particular object. A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like. It should be appreciated that any other suitable image recognition process may be used while remaining within the scope of the present subject matter.

According to still other embodiments, the image recognition process may use any other suitable neural network process. For example, step 220 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to obtain load size and main load fabric type. In addition, a K-means algorithm may be used for dominant color analysis to find individual color of fabrics to serve with warnings. Other image recognition processes are possible and within the scope of the present subject matter.

Step 230 includes adjusting at least one operating parameter of the washing machine appliance based on the load characteristic (e.g., as determined at step 220), such as selecting an operating cycle parameter, adjusting a water or detergent fill amount, or providing a user notification. As used herein, an “operating parameter” of washing machine appliance 100 is any cycle setting, operating time, component setting, spin speed, part configuration, or other operating characteristic that may affect the performance of washing machine appliance 100. Thus, references to operating parameter adjustments or “adjusting at least one operating parameter” are intended to refer to control actions intended to improve system performance based on the load characteristics. For example, adjusting an operating parameter may include adjusting an agitation time or an agitation profile, adjusting a water level, limiting a spin speed of wash basket 120, etc. Other operating parameter adjustments are possible and within the scope of the present subject matter.

For example, according to an exemplary embodiment, controller 166 may use the mask R-CNN image recognition process on images obtained at step 210 and may determine that the load of clothes is primarily delicate garments. As a result, controller 166 may further determine that cool water should be used (e.g., below a certain temperature), that the agitation profile should be gentle, and that the total wash time should be decreased. Controller 166 may automatically detect and implement such a wash cycle without requiring user input. By contrast, if a load of sheets or towels is detected, a large volume of hot water may be used with more detergent and an aggressive agitation profile. It should be appreciated that the exemplary load characteristics and the exemplary operating parameters described herein are only exemplary and not intended to limit the scope of the present subject matter in any manner.

In addition, adjusting the at least one operating parameter may include providing a user notification when a predetermined operating characteristic exists. For example, if step 220 results in the detection of an unwashable item, controller 166 may stop the wash cycle and provide a user notification, e.g., via an indicator on control panel 160 or by communication with a remote device via a wireless communication protocol, such as Wi-Fi or Bluetooth. Thus, for example, if a user inadvertently leaves their belt in a pair of pants thrown into the wash chamber 126, controller 166 may use images obtained by camera assembly 170 to detect the belt and instruct the user to remove the belt before the wash cycle commences. Similarly, if step 220 detects a single light item in a load of dark clothes or a single dark item in a load of light clothes, a user may be notified of such condition or washing machine appliance 100 may reduce the temperature of water added during a wash cycle to reduce the likelihood of bleeding between the different color articles. According to another exemplary embodiment, the unwashable item may be a child, a pet, or any other item that is not intended for washing or drying. It should be appreciated that the items identified herein as “unwashable” are only exemplary and are not intended to limit the scope of the present subject matter.

FIG. 4 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using washing machine appliance 100 as an example, it should be appreciated that these methods may be applied to the operation of any suitable washing machine appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry appliance comprising:
a cabinet;
a basket rotatably mounted within the cabinet and defining a chamber configured for receiving of a load of clothes;
a camera mounted within the cabinet in view of the chamber;
a controller operably coupled to the camera, the controller being configured for:
obtaining one of more images of the load of clothes in the chamber using the camera;
analyzing the one or more images using a neural network image recognition process to determine a load characteristic of the load of clothes; and
adjusting at least one operating parameter of the laundry appliance based on the load characteristic.

2. The laundry appliance of claim 1, wherein obtaining the one of more images of the load of clothes comprises:
obtaining a first image;
tumbling the clothes; and
obtaining a second image.

3. The laundry appliance of claim 1, further comprising:
a tub light for illuminating the chamber, wherein the controller is further configured for turning on the tub light prior to obtaining the one or more images of the load of clothes.

4. The laundry appliance of claim 1, wherein the image recognition process comprises a region based convolution neural network (R-CNN) image recognition process with image segmentation.

5. The laundry appliance of claim 1, wherein the load characteristic comprises at least one of a fabric type, a load color, or a load size.

6. The laundry appliance of claim 5, wherein the load color is white, light, dark, or mixed.

7. The laundry appliance of claim 1, wherein adjusting the at least one operating parameter comprises:
selecting an operating cycle based on the load characteristic.

8. The laundry appliance of claim 1, wherein adjusting the at least one operating parameter comprises:
dispensing a desired amount of detergent based on the load characteristic.

9. The laundry appliance of claim 1, wherein adjusting the at least one operating parameter comprises:
providing a user notification when a predetermined operating characteristic exists.

10. The laundry appliance of claim 1, wherein the load characteristic is the presence of an unwashable item, and wherein adjusting the at least one operating parameter comprises stopping the wash cycle.

11. The laundry appliance of claim 1, wherein the load characteristic is a dark item in a load of light or white clothes, and wherein adjusting the at least one operating parameter comprises reducing a temperature of a flow of water into the chamber.

12. The laundry appliance of claim 1, further comprising:
a door rotatably mounted to the cabinet for providing selective access to the chamber; and
a gasket positioned between wherein the door and the cabinet, wherein the camera is mounted in the gasket.

13. The laundry appliance of claim 1, wherein the camera is mounted behind a hydrophobic clear lens.

14. A method of operating a laundry appliance, the laundry appliance comprising a basket rotatably mounted within a cabinet and defining a chamber configured for receiving of a load of articles, and a camera mounted within the cabinet in view of the chamber, the method comprising:
obtaining one of more images of the load of clothes in the chamber using the camera;
analyzing the one or more images using a neural network image recognition process to determine a load characteristic of the load of clothes; and
adjusting at least one operating parameter of the laundry appliance based on the load characteristic.

15. The method of claim 14, wherein the image recognition process comprises a region based convolution neural network (R-CNN) image recognition process with image segmentation.

16. The method of claim 14, wherein the load characteristic comprises at least one of a fabric type, a load color, or a load size.

17. The method of claim 14, wherein adjusting the at least one operating parameter comprises:
selecting an operating cycle based on the load characteristic.

18. The method of claim 14, wherein adjusting the at least one operating parameter comprises:
dispensing a desired amount of detergent based on the load characteristic.

19. The method of claim 14, wherein the load characteristic is the presence of an unwashable item, and wherein adjusting the at least one operating parameter comprises stopping the wash cycle.

20. The method of claim 14, wherein the load characteristic is a dark item in a load of light or white clothes, and wherein adjusting the at least one operating parameter comprises reducing a temperature of a flow of water into the chamber.
